(19) United States
(12) Patent Application Publication
(10) Pub. No.: US 2020/0067389 A1
(43) Pub. Date: Feb. 27, 2020

(54) COIL STRUCTURE AND COIL ASSEMBLING METHOD

(71) Applicant: KABUSHIKI KAISHA TOSHIBA, Minato-ku (JP)

(72) Inventors: Taizo TOMIOKA, Yokohama (JP); Yoshinori NAKASHIMA, Yokohama (JP)

(73) Assignee: KABUSHIKI KAISHA TOSHIBA, Minato-ku (JP)

(21) Appl. No.: 16/358,368

(22) Filed: Mar. 19, 2019

(30) Foreign Application Priority Data
Aug. 24, 2018 (JP) 2018-156848

(51) Int. Cl. H02K 15/00; H02K 3/24; H02K 3/50; F16L 13/08

(52) U.S. Cl. CPC H02K 15/0093; F16L 13/08; H02K 3/505; H02K 3/24

(57) ABSTRACT

According to an embodiment, a coil assembling method comprises: a bundling step bundling coil elements including a hollow coil element and extending parallel to one another, thereby forming a coil element bundle; a mold-setting step setting a mold around the coil element bundle formed in the bundling step; a first brazing step supplying a first brazing material into the mold while heating at least one of the first brazing material and the coil element bundle, thereby filling the mold with the first brazing material; a mold-removing step removing the mold after cooling and hence solidifying the first brazing material; and a second brazing step brazing a water supply/drain box to an end of the coil element bundle brazed with the first brazing material by using a second brazing material thereby communicating a hollow part of the hollow coil element with an inner space of the water supply/drain box.

### CROSS-REFERENCE TO RELATED APPLICATION

This application is based upon and claims the benefit of priority from Japanese Patent Application No. 2018-156848, filed on Aug. 24, 2018; the entire content of which is incorporated herein by reference.

### FIELD

The present invention relates to a coil structure and a coil assembling method.

### BACKGROUND

As a structure of the stator coil for rotating electrical machines such as huge generators, there is a known structure in which stator coil elements are bundled at the ends in the form of a lattice, and are brazed to a water supply/drain box which is also called a clip. In this case, some of the stator coil elements have a hollow structure, and cooling water flows through the hollow coil elements via the water supply/drain boxes. In the present specification, the expression of “braze” and “brazing” may include solder and soldering, respectively.

### BRIEF DESCRIPTION OF THE DRAWINGS

FIG. 1 is an elevational view showing a coil structure according to a first embodiment of the invention.

FIG. 2 is an elevational cross-sectional view showing the major parts of the coil structure according to the first embodiment.

FIG. 3 is a flowchart of a coil assembling method according to the first embodiment of the invention.

FIG. 4 is a perspective view showing major parts of the coil element in the coil structure according to the first embodiment.

FIG. 5 is an elevational view showing the coil elements being bent and bundled in a mold in the coil assembling method according to the first embodiment.

FIG. 6 is an enlarged perspective view of the major parts of the coil elements in the state shown in FIG. 5.

FIG. 7 is an elevational cross-sectional view showing the coil elements placed in a mold and a wire-shaped brazing material inserted in the mold.

FIG. 8 is an elevational view showing the coil elements, each undergone the first brazing step, then removed from the mold and cut in the first brazed part, in the coil assembling method according to the first embodiment.

FIG. 9 is an elevational cross-sectional view showing the major parts of a coil structure according to a second embodiment of the invention.

FIG. 10 is a flowchart illustrating the sequence of a coil assembling method according to the second embodiment of the invention.

FIG. 11 is an enlarged perspective view showing the coil elements bundled and the sleeve mounted on the bundle of coil elements in the coil assembling method according to the second embodiment.

### DETAILED DESCRIPTION

The embodiments of the invention aim to suppress brazing deficiencies which may occur in brazing the ends of the coil elements to the water supply/drain box, such as forming of voids among the each coil elements or between the coil element bundle and the water supply/drain box.

According to an aspect of the present invention, there is provided a coil assembling method comprising: a bundling step bundling a plurality of coil elements including at least one hollow coil element and extending parallel to one another, thereby forming a coil element bundle; a mold-setting step setting a mold around the coil element bundle formed in the bundling step; a first brazing step supplying a first brazing material into the mold while heating at least one of the first brazing material and the coil element bundle, after the mold-setting step, thereby filling the mold with the first brazing material; a mold-removing step removing the mold after cooling and hence solidifying the first brazing material, after the first brazing step; and a second brazing step brazing a water supply/drain box, in a liquid-tight fashion, to an end of the coil element bundle brazed with the first brazing material by using a second brazing material, after the first mold-removing step, thereby communicating a hollow part of the hollow coil element with an inner space of the water supply/drain box.

According to another aspect of the present invention, there is provided a coil assembling method comprising: a bundling step bundling ends of a plurality of coil elements including at least one hollow coil element and extending parallel to one another, thereby forming a coil element bundle; a sleeve-setting step setting a sleeve around the coil element bundle formed in the bundling; a welding step connecting the sleeve to the coil element bundle by means of welding; a first brazing of supplying a first brazing material into the sleeve while heating at least one of the first brazing material, the sleeve and the coil element bundle, after the welding step, thereby filling the sleeve with the first brazing material; and a second brazing step brazing a water supply/drain box, in a liquid-tight fashion, to the sleeve brazed with the first brazing material by using the second brazing material, after the first brazing step, thereby communicating a hollow part of the hollow coil element with an inner space of the water supply/drain box.

According to another aspect of the present invention, there is provided a coil structure comprising: a coil element bundle having a plurality of coil elements including at least one hollow coil element, extending parallel to one another, and coupled together at ends by a first brazing material; and a water supply/drain box brazed, in a liquid-tight fashion, to an end of the coil element bundle by using a second brazing material, and communicating with a hollow part of the hollow coil element, wherein in the vicinity of the first brazing material coupling the coil elements together, adhesive is filled and connecting the coil elements to one another.

According to another aspect of the present invention, there is provided a coil structure comprising: a coil element bundle having a plurality of coil elements including at least one hollow coil element, extending parallel to one another, and bundled together at ends; a sleeve arranged, surrounding outer circumference of an end of the coil element bundle, and connected by welding to the coil element bundle, and filled with a first brazing material between the coil elements and between the sleeve and the coil elements, in a liquid-tight fashion; and a water supply/drain box brazed, in a liquid-tight fashion, to the sleeve by using a second brazing material, and communicating with a hollow part of the hollow coil element.

### FIRST EMBODIMENT

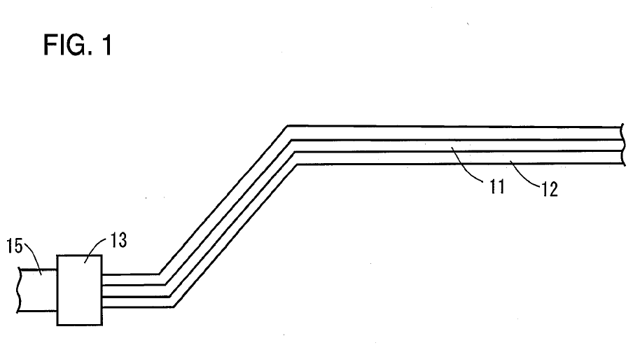

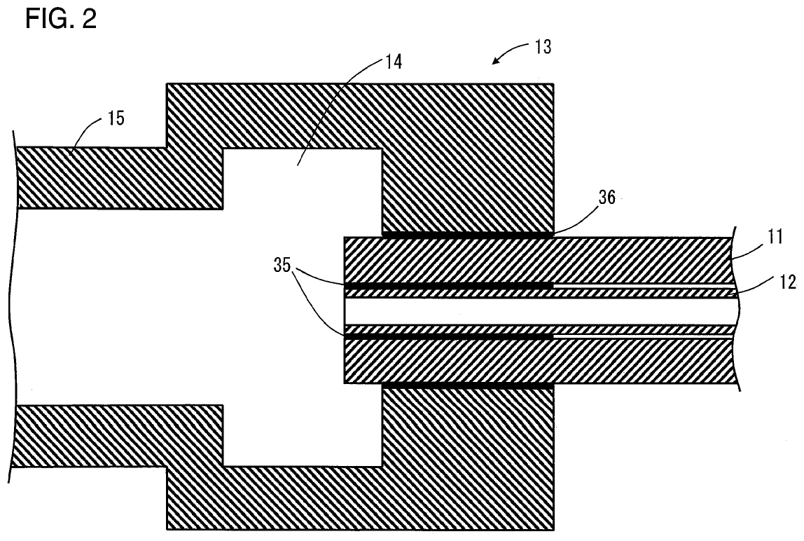

FIG. 1 is an elevational view showing a coil structure according to a first embodiment of the invention. FIG. 2 is an elevational cross-sectional view showing the major parts of the coil structure according to the first embodiment.

The coil structure is, for example, the coil-end assembly structure for the stator of a large generator. In the structure, a plurality of coil elements 11 and 12 extend parallel to one another and are connected to a water supply/drain box 13. Typically, the coil elements 11 and 12 include a plurality of hollow coil elements and a plurality of solid coil elements 12. At least one hollow coil element 11 is included. All coil elements may be hollow coil elements 11. The coil elements 11 and 12 are made of metal material having high electric conductivity, such as copper.

The coil elements 11 and 12 are connected to each other with a first brazing material 35 in a liquid-tight fashion. The coil elements 11 and 12 are connected to the water supply/drain box 13 with a second brazing material 36 in a liquid-tight fashion. The hollow parts in the hollow coil elements 11 communicate with an inner space 14 in the water supply/drain box 13.

The coil elements 11 and 12 are bent at middle part.

A cooling pipe 15 is connected to the water supply/drain box 13. The cooling pipe 15 communicates with the inner space 14 in the water supply/drain box 13. Therefore, the cooling water supplied from the cooling pipe 15 flows via the inner space 14 in the water supply/drain box 13 into the hollow parts of the coil elements 11, and cools the coil elements 11 and 12.

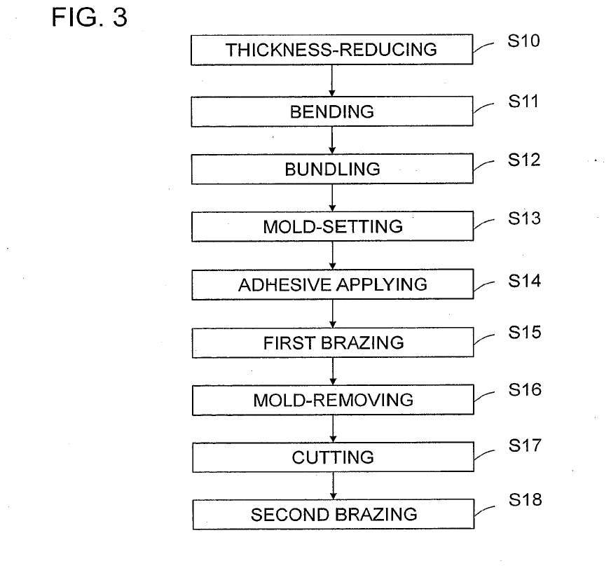

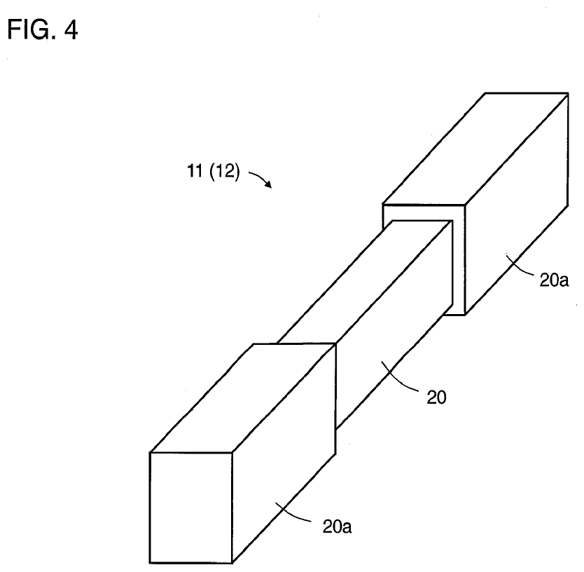

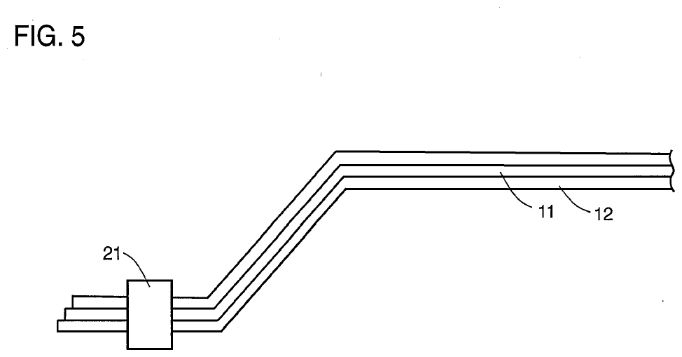

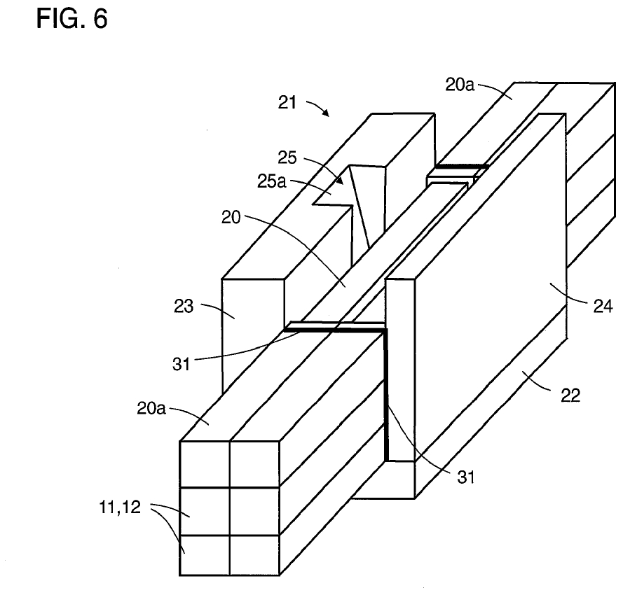

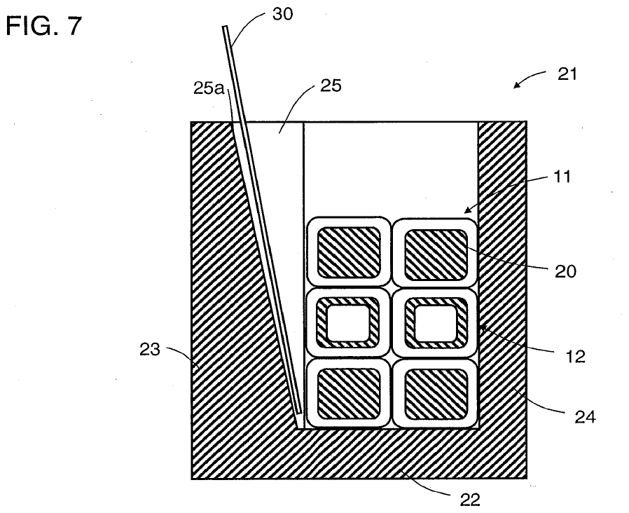

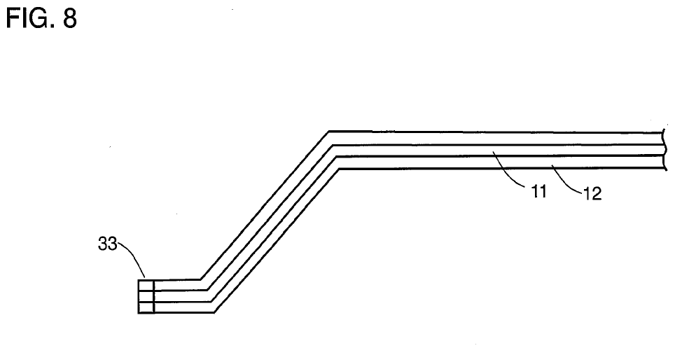

FIG. 3 is a flowchart illustrating a sequence of a coil assembling method according to the first embodiment of the invention. FIG. 4 is a perspective view showing major parts of the coil element in the coil structure according to the first embodiment. FIG. 5 is an elevational view showing the coil elements being bent and bundled in a mold in the coil assembling method according to the first embodiment. FIG. 6 is an enlarged perspective view of the major parts of the coil elements in the state shown in FIG. 5. FIG. 7 is an elevational cross-sectional view showing the coil elements placed in a mold and a wire-shaped brazing material inserted in the mold. FIG. 8 is an elevational view showing the coil elements, each undergone the first brazing step, then removed from the mold and cut in the first brazed part, in the coil assembling method according to the first embodiment.

The sequence of the coil assembling method according to the first embodiment will be explained with reference to the flowchart of FIG. 3.

First, the coil elements 11 and 12 are cut, each at the part to be brazed, thereby forming a thin part 20 each, as shown in FIG. 4 (thickness reduction step S10). The parts of the coil elements 11 and 12, other than the thin part 20, shall be hereinafter called “thick parts 20a.”

Next, the coil elements 11 and 12 are bent, forming a step-like shape, for example, as is illustrated in FIG. 1 (bending step S11).

Then, the coil elements 11 and 12 are arranged, forming a lattice, and are then bundled (bundling step S12). As will be described later with reference to FIG. 7, the coil elements 11 and 12 each has a cross-sectional shape that is almost a rectangle (in a cross-section perpendicular to the direction in which the coil element extends). The bundle of the coil elements 11 and 12 as a whole has a cross section that is almost rectangular. If the coil elements 11 and 12 are bundled, with their thick parts 20a arranged and contacting one another, a gap will be made between the thin parts 20 of any two adjacent coil elements 11 and 12. This promotes the flowing of the brazing material in the first brazing step S15 described later, preventing bubbles from remaining.

Next, as shown in FIG. 5 to FIG. 7, a mold 21 is set outside the coil elements 11 and 12 bundled together (mold-setting step S13). The mold 21 is made of heat-resisting material such as plaster or ceramics. The mold 21 has a flat bottom plate 22, a first side plate 23 standing from one edge of the bottom plate 22, and a second side plate 24 standing from the other edge of the bottom plate 22. The bottom plate 22, the first side plate 23 and the second side plate 24 are formed integral. Alternatively, these plates may be formed one by one and then be adhered to one another, thereby to form an integral component. The coil elements 11 and 12 are sandwiched by the first side plate 23 and the second side plate 24. The mold 21 has an opening in the top, and is opened at the top.

In the case shown in FIG. 6 and FIG. 7, the coil elements 11 and 12 have an almost rectangular cross section each. Three pairs of coil elements are disposed. The coil elements of each pair are arranged parallel in the horizontal direction, and three pairs are laid one on another in the vertical direction. That is, six coil elements 11 and 12 are arranged, constituting a block that has an almost rectangular cross section. The arrangement of coil elements is not limited to this, nevertheless.

The mold 21 is arranged, covering the coil elements 11 and 12 along the entire length of the thin parts of the coil elements. The mold 21 is so arranged that its sides near its both ends cover the thick parts 20a of the coil elements 11 and 12.

The first side plate 23 is thicker than the second side plate 24, and has a groove (brazing material passage) 25 that extends almost vertically from the upper edge of the inner surface of the first side plate 23 toward the upper surface of the bottom plate 22. The bottom 25a of the groove 25 inclines, gradually approaching the coil elements 11 and 12 mounted on the bottom plate 22, as the bottom 25a approaches the bottom plate 22. In other words, a surface of the bottom 25a of the groove (brazing material passage) 25 is getting closer to the coil elements 11 and 12 at a lower part than at an upper part. Therefore, as the wire-shaped brazing material 30, i.e., brazing material 35, is inserted into the groove 25 from above, it can contact the lowermost coil elements 11 and 12, without bringing the brazing material 30 into contact with the upper coil elements 11 and 12 or with the intermediate coil elements 11 and 12. The wire-shaped brazing material 30 is turned to be the brazing material 35 in the first brazing step S15 explained later.

After performing the mold-setting step S13, heat-resisting adhesive 31 is applied to both ends of the mold 21 (adhesive applying step S14). The heat-resisting adhesive 31 contains, for example, inorganic filler. The heat-resisting adhesive 31 fills up the gap between the coil elements 11 and 12 at their thick parts 20a, and fills up the gap between the coil elements 11 and 12, on one hand, and the mold 21, on the other hand. In the next step, i.e., first brazing step S15, the heat-resisting adhesive 31 prevents the molten brazing material from leaking outside from the both ends of the mold 21.

Next, the coil elements 11 and 12 are heated, the wire-shaped brazing material 30 is inserted from above into the groove 25, and brazing is performed (first brazing step S15) The heating of the coil elements 11 and 12 is performed, for example, by means of electromagnetic induction heating, by using an electromagnetic induction heating coil (not shown) wound around protruding part of the coil elements 11 and 12 which protrude outside from both ends of the mold 21. Then, the wire-shaped brazing material 30 is lowered from above, along the bottom 25a of the groove 25, as described above. The lower end of the brazing material 30 is thereby brought into contact with the lowermost coil elements 11 and 12.

The brazing material 30 is thereby melted with the heat transferred from the coil elements 11 and 12, and the first brazing material 35 so melted fills the mold 21 from the lower part thereof. Since the mold 21 is gradually filled with the first brazing material 35, first at its lower part, bubbles can easily leave the first brazing material 35 upwards. The possibility for the bubbles to stay in the molten brazing material is therefore low. In this embodiment, the brazing (i.e. first brazing step S15) is performed by heating the coil elements 11 and 12. However, the brazing may also be performed by heating the brazing material 30 or by heating all of the brazing material 30, the coil elements 11 and 12.

Since the coil elements 11 and 12 each has a thin part 20, the gap between the coil elements 11 and 12 is relatively large in the mold 21. This promotes the flowing of the melted first brazing material 35. The possibility for the bubbles to stay in the molten brazing material is thereby lowered further.

At this time, the heat-resisting adhesive 31 suppresses the outward flow of the molten brazing material from the mold 21.

Then, the heating is stopped. After the heat is released and the first brazing material 35 therefore solidifies, the mold 21 is removed (mold-removing step S16)

Next, as shown in FIG. 8, the parts 33 of the coil elements 11 and 12 that have been brazed in the first brazing step S15 are cut in a flat plane perpendicular to the direction of the coil elements 11 and 12 (cutting step S17).

Further, the water supply/drain box 13 is attached, covering the parts of the coil elements 11 and 12 that have been cut in the cutting step S17, and the coil elements 11 and 12 are then brazed to the water supply/drain box 13 by using a second brazing material 36 (second brazing step S18). The solidus temperature of the second brazing material 36 used in the second brazing step S18 is lower than the solidus temperature of the first brazing material 35 used in the first brazing step S15. The heating temperature in the second brazing step S18 is set lower than the solidus temperature of the first brazing material 35. Thus, the first brazing material 35 can be prevented from melting or softening in the second brazing step S18.

After the second brazing step S18 is performed, the cooling pipe 15 is connected to the water supply/drain box 13 by means of, for example, brazing. The cooling pipe 15 may be connected to the water supply/drain box 13, prior to the second brazing step S18.

In the first embodiment, brazing deficiencies, such as inadequate brazing material wetting, insufficient wet length and void generation between the coil elements 11 and 12 and between the coil elements 11 and 12, on one hand, and the water supply/drain box 13, on the other, can be suppressed, as described above, in the process of brazing the coil ends to the water supply/drain box 13.

### SECOND EMBODIMENT

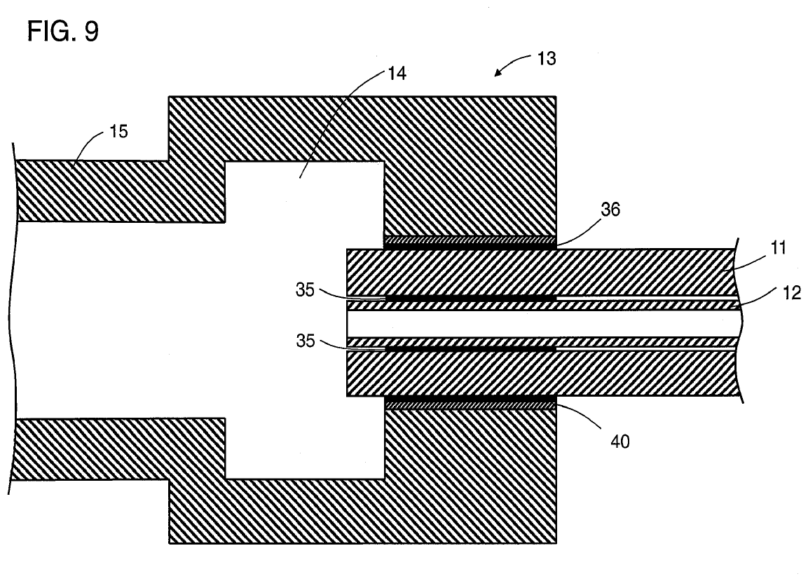

FIG. 9 is an elevational cross-sectional view showing the major parts of a coil structure according to a second embodiment of the invention.

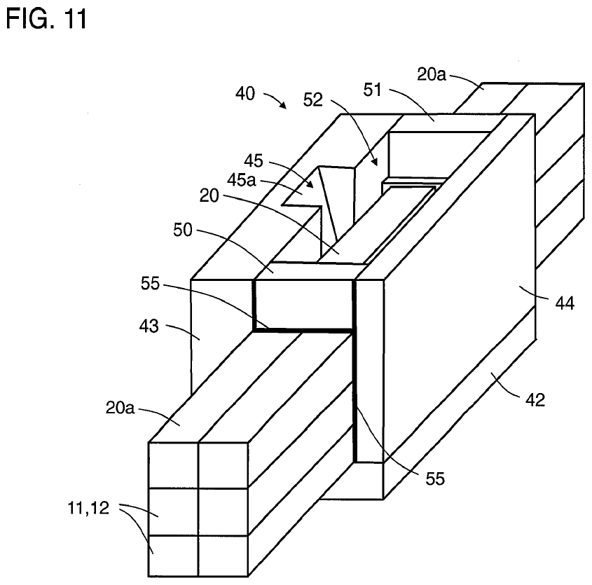

In the coil structure according to the second embodiment, a sleeve 40 is arranged, surrounding the bundle of coil elements 11 and 12. The sleeve 40 is secured to the water supply/drain box 13. The sleeve 40 is made of metal material having high electric conductivity, such as copper. The sleeve 40 is brazed to the coil elements 11 and 12 with the first brazing material in a liquid-tight fashion. The sleeve 40 and the water supply/drain box 13 are brazed to each other in a liquid-tight fashion with the second brazing material. The configuration of the sleeve 40 will be described later with reference to FIG. 11. The second embodiment is similar to the first embodiment in other respects.

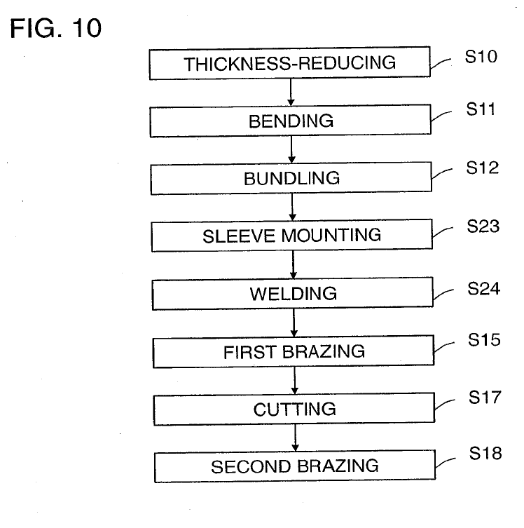

FIG. 10 is a flowchart illustrating the sequence of a coil assembling method according to the second embodiment of the invention. FIG. 11 is an enlarged perspective view showing the coil elements bundled and the sleeve mounted on the bundle of coil elements in the coil assembling method according to the second embodiment.

With reference to the flowchart of FIG. 10, the coil assembling method according to the second embodiment will be described.

The thickness reduction step S10, the bending step S11 and the bundling step S12 are same as those performed in the first embodiment.

After performing the bundling step S12, the sleeve 40 is mounted on the bundle of coil elements 11 and 12 (sleeve-mounting step S23) as shown in FIG. 11. The mold 21 used in the first embodiment is replaced with the sleeve 40. However, the sleeve 40 is never removed. The sleeve 40 is similar, in structure, to the mold 21 used in the first embodiment. As shown in FIG. 11, the sleeve 40 has a bottom plate 42, a first side plate 43, and a second side plate 44, and has an opening at the top. In the first side plate 43, a groove (brazing material passage) 45 is formed.

The first side plate 43 and the second side plate 44 sandwich, between them, the bundle of coil elements 11 and 12. Between the upper parts of the first and second side plates 43 and 44, end plates 50 and 51 are arranged, extending up and down from the upper ends of the coil elements 11 and 12 to the upper edges of the first side plate 43 and the second side plate 44. Above the coil elements 11 and 12, a brazing material accumulating space 52 is formed, surrounded by the first and second side plates 43 and 44 and the end plates 50 and 51. The end plates 50 and 51 are made of metal material having high electric conductivity, such as copper.

Next, the coil elements 11 and 12 at their thick parts 20a are connected by welding, and the coil elements 11 and 12 are connected to the sleeve 40 by welding (welding step S24). The welding step S24 is performed in place of the adhesive-applying step S14 of the first embodiment. In the welding step S24, the gap is filled with a welded part 55. Therefore, the first brazing material can be prevented from flowing outside the sleeve 40 in the first brazing step S15.

Then, the first brazing step S15 is performed in a similar way as in the first embodiment. In the second embodiment, however, the first brazing material is accumulated in the brazing material accumulating space 52 as the process approaches the end of the first brazing step S15. The opening made in the top of the sleeve 40 is thereby covered with the first brazing material. The first brazing step S15 can be performed by heating at least one of the brazing material 30, the sleeve 40 and the coil elements 11 and 12.

In the second embodiment, no steps equivalent to the mold-removing step S16 in the first embodiment are performed. The cutting step S17 similar to the cutting step S17 of the first embodiment is performed, and then, the second brazing step S18 in the second embodiment is performed. In the second brazing step S18, however, the sleeve 40 and the water supply/drain box 13 are connected by using the second brazing material.

The second embodiment can achieve advantages similar to those attained in the first embodiment, and can save labor because the mold-removing step need not be performed.

### OTHER EMBODIMENTS

In the embodiments described above, the first brazing material and the second brazing material are different. Nonetheless, the first brazing material and the second brazing material can be identical.

In the embodiments described above, the mold 21 or the sleeve 40 has a groove 25 that is used as a passage for supplying the wire-shaped brazing material. The passage for supplying the brazing material need not be a groove. Instead of a groove, a through hole (not shown) may be cut in the mold 21 or the sleeve 40. It is not absolutely necessary to provide a brazing material passage such as a groove or a through hole.

Moreover, the cutting step S17 is unnecessary if the coil elements 11 and 12 cut to an appropriate length are used.

The thickness reduction step S10 and the bending step S11 can be performed in reverse order.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coil assembling method comprising:
a bundling step bundling a plurality of coil elements including at least one hollow coil element and extending parallel to one another, thereby forming a coil element bundle;
a mold-setting step setting a mold around the coil element bundle formed in the bundling step;
a first brazing step supplying a first brazing material into the mold while heating at least one of the first brazing material and the coil element bundle, after the mold-setting step, thereby filling the mold with the first brazing material;
a mold-removing step removing the mold after cooling and hence solidifying the first brazing material, after the first brazing step; and
a second brazing step brazing a water supply/drain box, in a liquid-tight fashion, to an end of the coil element bundle brazed with the first brazing material by using a second brazing material, after the first mold-removing step, thereby communicating a hollow part of the hollow coil element with an inner space of the water supply/drain box.

2. The coil assembling method according to claim 1, further comprising:
an adhering step adhering the mold to the coil element bundle by using adhesive, after the mold-setting step and before the first brazing step.

3. The coil assembling method according to claim 1, wherein
the mold has an opening at an upper part, and a brazing material passage extending downward from the opening; and
the first brazing step includes:
an insertion step inserting the first brazing material into the mold from the opening through the brazing material passage to avoid touching the brazing material to an upper part of the coil bundle before reaching the brazing material to a lower part of the coil bundle.

4. The coil assembling method according to claim 3, wherein
the brazing material passage of the mold is inclined, a surface of the brazing material passage being closer to the coil elements bundle at the lower part than at the upper part.

5. The coil assembling method according to claim 1, further comprising:
before the bundling step, a thickness reduction step forming a thin part on at least one of the coil elements, the thickness reduction step being performed to a part of the coil element which is to be set in the mold.

6. The coil assembling method according to claim 1, wherein solidus temperature of the first brazing material is higher than solidus temperature of the second brazing material.

7. A coil assembling method comprising:
a bundling step bundling ends of a plurality of coil elements including at least one hollow coil element and extending parallel to one another, thereby forming a coil element bundle;
a sleeve-setting step setting a sleeve around the coil element bundle formed in the bundling step;
a welding step connecting the sleeve to the coil element bundle by welding;
a first brazing step supplying a first brazing material into the sleeve while heating at least one of the first brazing material, the sleeve and the coil element bundle, after the welding step, thereby filling the sleeve with the first brazing material; and
a second brazing step brazing a water supply/drain box, in a liquid-tight fashion, to the sleeve brazed with the first brazing material by using the second brazing material, after the first brazing step, thereby communicating a hollow part of the hollow coil element with an inner space of the water supply/drain box.

8. The coil assembling method according to claim 7, wherein
the sleeve has an opening in an upper part, and a brazing material passage extending downward from the opening; and
the first brazing step includes:
an insertion step inserting the first brazing material into the sleeve from the opening through the brazing material passage, a distal end of the first brazing material bringing into contact with a lower part of the coil element bundle, without contacting with an upper part of the coil element bundle.

9. The coil assembling method according to claim 8, wherein the brazing material passage is inclined, a surface of the brazing material passage being closer to the coil element bundle at the lower part than at the upper part.

10. The coil assembling method according to claim 7, further comprising:
before the bundling step, a thickness reduction step forming a thin part on at least one of the coil elements, the thickness reduction step being performed to a part of the coil element which is to be set in the sleeve.

11. The coil assembling method according to claim 7, wherein solidus temperature of the first brazing material is higher than solidus temperature of the second brazing material.

12. A coil structure comprising:
a coil element bundle having a plurality of coil elements including at least one hollow coil element, extending parallel to one another, and coupled together at ends by a first brazing material; and
a water supply/drain box brazed, in a liquid-tight fashion, to an end of the coil element bundle by using a second brazing material, and communicating with a hollow part of the hollow coil element,
wherein at least part of the plurality of coil elements have a thin part each, which is coupled together by the first brazing material.

13. The coil structure according to claim 12, wherein solidus temperature of the first brazing material is higher than solidus temperature of the second brazing material.

14. A coil structure comprising:
a coil element bundle having a plurality of coil elements including at least one hollow coil element, extending parallel to one another, and bundled together at ends;
a water supply/drain box brazed in a liquid-tight fashion to the sleeve by using a second brazing material;
a sleeve arranged, surrounding outer circumference of an end of the coil element bundle, and welded to the coil element bundle, wherein a first brazing material is filled among the coil elements and between the sleeve and the coil elements to be a liquid-tight; and
a water supply/drain box brazed in a liquid-tight fashion to the sleeve by using a second brazing material.

15. The coil structure according to claim 14, wherein at least part of the plurality of coil elements have a thin part each, which is coupled together by the first brazing material.

16. The coil structure according to claim 14, wherein solidus temperature of the first brazing material is higher than solidus temperature of the second brazing material.
